(19) United States
(12) Patent Application Publication
(10) Pub. No.: US 2003/0036972 A1
(43) Pub. Date: Feb. 20, 2003

(54) Material procurement apparatus and material procurement method

(76) Inventors: Jun Zamma, Chiba (JP); Yasuhiro Yuki, Chiba (JP); Akio Sato, Chiba (JP)

Correspondence Address: CANTOR COLBURN LLP, 55 Griffin Road South, Bloomfield, CT, 06002, US

(21) Appl. No.: 10/219,868

(22) Filed: Aug. 15, 2002

(30) Foreign Application Priority Data
Aug. 20, 2001 (JP) 2001-248908
Jul. 24, 2002 (JP) 2002-215114

(51) Int. Cl. G06F 17/60

(52) U.S. Cl. 705/26

(57) ABSTRACT

A material procurement apparatus prepares specifications of materials to be procured and a format utilized at the time material suppliers prepare quotation, and stores the specifications and the format in a storage. Then, the apparatus sends a request for quotation to the material suppliers, and requests the material suppliers to access a specifications storage and a format storage and download requested specifications and format so as to prepare replies for the quotation request. Thereafter, results of the quotation received from maker terminals are stored in a quotation data storage. A data synthesizing unit in the material procurement apparatus synthesizes a plurality of quotation results and the format, and prepares a table for the quotation results. This table is presented to the material buyer so as to support the material buyer in determining a material supplier.

### BACKGROUND OF THE INVENTION

1. Field of the Invention

The present invention relates to a technology that realizes a method by which a material purchaser procures materials on a network.

2. Description of the Related Art

In recent years, with the expanding use of the Internet, there has been an ever-growing volume of electronic commercial transactions (hereinafter also referred to as electronic commerce) among enterprises. This mode of transactions can facilitate purchase of all kinds of materials with ease and at low cost.

Nevertheless, the conventional electronic commerce has only dealt with goods and materials whose specifications can be identified by simple product codes or through fixed formats, such being mainly standardized items or cataloged items. In contrast thereto, in the procurement of materials necessary for the construction of an industrial plant, including valves, pumps, motors, instrumentation and so forth, a transaction system is normally employed in which a party who requests a quotation determines the basic specifications of the materials desired and a maker who gives a quotation therefor, determines the detailed specifications. Specifications required by the quotation requesting party in such material procurement are of such nature that there are those that must be satisfied by all means and the others that are not. Accordingly, the maker lists up several candidate materials close to the required specifications and proposes the quotation requesting party to select one that is most suitable in consideration of the price and the delivery time or lead time. For example, the maker may ask the quotation requesting party about the possibility of minor design changes if such changes in material or some other features may shorten the lead time or reduce the cost significantly. To this type of material procurement practice, the conventional-type electronic commercial transaction has not always responded adequately.

Moreover, material procurement operation for construction of an industrial plant and the like is characteristic in that there are a great variety of necessary materials and the specifications thereof can vary from maker to maker. Moreover, there are many technical specifications and drawings to be submitted at the delivery of the materials. Besides, in many cases a method is adopted in which shape information, on the material, stored in a shape-designing CAD is delivered to the material purchaser from the material supplier in a stage after the order has been placed. Thus, the material procurement operation for the construction of an industrial plant and the like involves far more complex and peculiar processes than the ordinary procurement of materials.

The conventional practices in material procurement operation for the construction of an industrial plant and the like have so far relied on the exchange of paper documents. Yet, technical evaluation and cost evaluation while comparing a plurality of quotations received in paper documents not only requires much labor but also entails the possibility of losing the documents. Furthermore, it is difficult to compare and evaluate the specifications, costs and delivery time efficiently in a uniform manner.

To solve these problems, there have been attempts to employ a method for issuing and accepting orders based on the exchange of data over a network. To employ such a method, however, it is normally required that the maker be in possession of a predetermined set of hardware. Yet, the electronic data of quotations sent by the makers are prepared in varied formats of their own, so that, as with the paper documents, it is difficult to compare and evaluate the specifications, costs and delivery time offered by several companies efficiently in a uniform manner. Moreover, the increased size of data sent and received may cause the handling to become even more difficult and inconvenient.

### SUMMARY OF THE INVENTION

The present invention has been made in view of foregoing problems, and an object thereof is to reduce the burden on material suppliers and material purchaser in the transmission and reception of data and to provide a material procurement technology that realizes efficient and accurate comparison of a plurality of the material suppliers.

According to an aspect of the present invention, there is provided a material procurement apparatus, connected to material suppliers via a network, comprising: a quotation request generating unit which prepares a request for quotation and sends the quotation request to the material suppliers; and an assessment unit which receives quotation data received from the material suppliers, wherein the quotation request generating unit includes: a specifications preparing means for preparing required specifications of material; specifications storage means, accessible from the material suppliers, for storing the required specifications; format preparing means for preparing a format utilized when the material suppliers prepare quotation; format storage means, accessible from the material suppliers, for storing the format; and quotation requesting means which sends to the material suppliers a quotation request including an inquiry about a specification and a price of a product that can be supplied, and which requires the material suppliers to access the specifications storage means and the format storage means to download the required specifications and the format and to prepare replies to the quotation request along the format by referring to the required specifications, and wherein the assessment unit includes: quotation result storage means which receives quotation results prepared along the format and stores the quotation results; and a data synthesizing unit which synthesizes a plurality of quotation results received from a single or plurality of material supplier(s) and the format read out of the format storage means, and prepares a table for the plurality of quotation results.

According to another aspect of the present invention, there is provided a material procurement system, including a material procurement apparatus and material suppliers connected to the material procurement apparatus via a network, in which the material procurement apparatus comprises: a quotation request generating unit which prepares a request for quotation and sends the quotation request to the material suppliers; and an assessment unit which receives quotation data received from the material suppliers, wherein the quotation request generating unit includes: a specifications preparing means for preparing required specifications of material; specifications storage means, accessible from the material suppliers, for storing the required specifications; format preparing means for preparing a format utilized when the material suppliers prepare quotation; format storage means, accessible from the material suppliers, for storing the format; and quotation requesting means which sends to the material suppliers a quotation request including an inquiry about a specification and a price of a product that can be supplied, and which requires the material suppliers to access the specifications storage means and the format storage means to download the required specifications and the format and to prepare replies to the quotation request along the format by referring to the required specifications, and in which the assessment unit includes: quotation result storage means which receives quotation results prepared along the format and stores the quotation results; and a data synthesizing unit which synthesizes a plurality of quotation results received from a single or plurality of material supplier(s) and the format read out from the format storage means, and prepares a table for the plurality of quotation results, and wherein each of the material suppliers is equipped with: a request receiving unit which receives a request for quotation from the material procurement apparatus; and a quotation unit which downloads the required specifications and the format by accessing the specifications storage means and the format storage means when the quotation request is received, and which prepares a reply to the quotation request in compliance with the format by referring to the required specifications.

The material procurement apparatus may adopt a structure such that the assessment unit further includes a display unit for displaying the table, and the display unit displays an item that does not meet any of the required specifications in an emphasized manner using highlighted display and so forth.

Moreover, the material procurement apparatus may adopt a structure such that the assessment unit further includes supplier management means which receives data on a specified supplier from a material buyer and sends a purchase request to the specified supplier.

According to still another aspect of the present invention, there is provided a material procurement method utilizing a material procurement apparatus, connected to material suppliers via a network, including storage means accessible from the material suppliers, the method comprising: preparing required specifications and a format utilized when the material suppliers prepare quotation; storing the required specifications and the format in the storage means; sending to the material suppliers a quotation request including an inquiry about a specification and a price of a product that can be supplied, and requiring the material suppliers to access the storage means to download the required specifications and the format and to prepare replies to the quotation request along the format by referring to the required specifications; receiving quotation results prepared along the format, from the material suppliers; and synthesizing a plurality of quotation results received from a single or plurality of material supplier(s) and the format read out of the storage means, and preparing a table for the plurality of quotation results.

The material procurement method may further include displaying the table in a manner that an item that does not meet any of required specifications among the quotation results is emphasized by highlighted display or the like.

Moreover, the material procurement method may further include receiving data on a specified supplier from a material buyer after having displayed the table, and sending a purchase request to the specified supplier.

The present invention relates to not only a technology where mere prices and delivery time of materials are estimated but also a technology in which the material buyer communicates the required specifications to the material suppliers and in response thereto the material suppliers inform the material buyer of specifications of products that can be provided. At a stage when a plurality of replies are gathered, the material buyer compares a plurality of quotations in total consideration of prices, specifications, delivery time and so forth, and determines a supplier as appropriate. The present invention relates to a technology where such a process is already taken into consideration. Specifically speaking, the present invention provides a material procurement technology suitable for procurement of materials necessary for construction of an industrial plant, or materials used for daily living such as valves, pumps, motors, instrumentation and so forth.

According to the present invention, prepared is a format which is utilized at the time the material suppliers prepare quotation, and this format together with required specifications are sent to the material suppliers. The quotation to be received from the material suppliers is prepared in compliance with this format. The format may be prepared in a tabular format, for instance, and is prepared in a manner that numerical values required are inputted in blank columns of a table. Thus, quotation data received from the material suppliers can be received in a same format, so that the table can be prepared with ease. Moreover, for example, units to be used are provided and described in input columns of product specifications of the table, so that quotation data to be received are described in unified units. Accordingly, data are designed to be unified by use of the format, so that a plurality of material suppliers can be compared quickly and accurately.

Moreover, as for transmission of data to the material buyer from the material suppliers, there is no need of transmitting data combined with a format, instead, it suffices to send only data on product specifications, prices, deliver time and the like prepared along a format. Thus, at a material buyer side, comparable data can be obtained by synthesizing the data, sent from the material suppliers, and the format that corresponds thereto. Since data are exchanged in this manner, a burden on the material suppliers and the material buyer accompanied by exchange of data can be reduced.

According to the present invention, the format means a form utilized at the time the material buyer prepares quotation. If the format is defined as one that does not contain tag data, advantages will be gained, as will be described later, where workability in preparing the quotation improves and so forth. The “tag data” is one that describes structures (attributes, hyperlinks of data or the like) and modifying information (the size of characters or the like) of document in the markup languages such as HTML (HyperText Markup Language) and XML (extensible Markup Language), and the one that is arranged by <and > at the beginning and the end of a text, respectively.

Moreover, a system may be structured such that a material supplier downloads a macro instruction presenting the format, on application software utilized, together with the format, when the material supplier prepares quotation. In a case when the format contains the tag data, this macro instruction may contain an instruction to delete the tag data. Moreover, a structure may be implemented such that the quotation unit in the material procurement apparatus deletes the tag data.

It is to be noted that, in the present invention, quotation results received from the material suppliers usually contain specifications and prices of products. There are cases where the product specifications do not satisfy required specifications, and evaluation is carried out in consideration of both prices and the product specifications.

The structures according to the present invention have been described. However, it is to be noted that any arbitrary combination of these structural components, and the above-described expressions converted between method, apparatus, system, recoding medium, computer program and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

FIG. 1 shows a flow of material procurement method according to a first embodiment of the present invention.

FIG. 2 is a schematic diagram showing an outline structure of a system including a material procurement apparatus according to the first embodiment of the present invention.

FIG. 3 shows a method of evaluating quotation data.

FIG. 4 shows a function of a data synthesizing unit.

FIG. 5 shows an example of a sheet utilized at the time a maker prepares quotation.

FIG. 6 shows an example of a table by which quotation received from makers is compared.

FIG. 7 shows a procedure for preparing a synthesized quotation file.

FIG. 8 is a schematic diagram showing an outline structure of a system including a material procurement apparatus according to a second embodiment of the present invention.

FIG. 9 illustrates the format of data dealt with by the system shown in FIG. 8.

FIG. 10 shows a function of a data synthesizing unit according to the second embodiment.

FIG. 11 shows an example of a table by which quotation received from makers is compared.

### DETAILED DESCRIPTION OF THE INVENTION

The invention will now be described based on preferred embodiments with reference to the drawings that illustrate procurement of materials where the construction of an industrial plant is taken as an example, hereinafter. Used as a example here is a transaction using a system where a material purchaser determines the basic specifications and material suppliers determine the detailed specifications. The preferred embodiments do not intend to limit the scope of the present invention, but exemplify the invention. All of the features and the combinations thereof described in the embodiment are not necessarily essential to the invention.

It is to be noted that terms “material purchaser”, “material buyer” and “material procurer” are interchangeably used in this patent specification.

First Embodiment

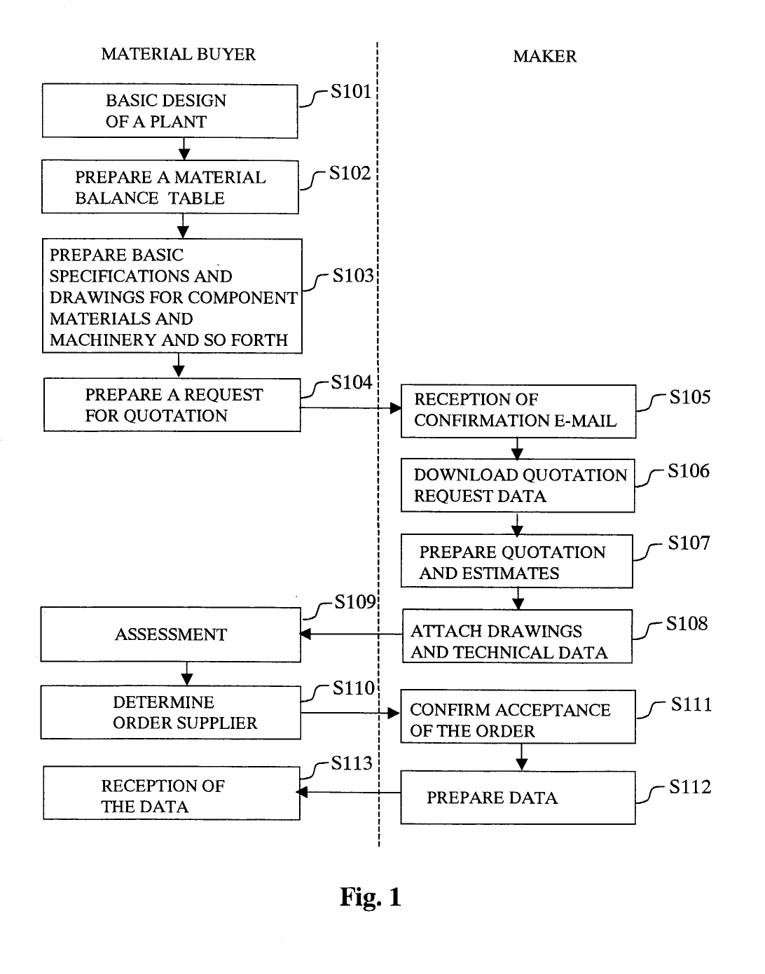

Referring to FIG. 1, a description will be given of a general flow of operation including a process of material procurement according to an embodiment of the present invention. A material buyer (also referred to as a material purchaser, hereinafter) first develops a basic design of a plant (S101) and, based thereon, prepares a material balance table that tabulates the temperatures, pressures, names of fluids, flow rates, and the like, in each of parts of the plant (S102). Consulting this material balance table, the material buyer then prepares basic specifications and drawings of materials to be purchased, such as component materials (valves, instruments and so forth) and machinery and other equipment (pumps, motors and so forth), to be positioned in each parts of the plant (S103). Then, based on the basic specifications and drawings, the material buyer prepares requests for quotation (S104) and transmits the quotation request to makers. The transmission of the requests for quotation is made in a manner such that quotation request data are stored in a database owned by the material buyer and confirmation electronic mail (Email) is sent to the makers, who are recipients of the requests for quotation, asking them to access said database and download the data therefrom. Upon receipt of the confirmation Email (S105), each of the makers downloads the quotation request data (S106), prepares its quotation according to the request (S107), and transmits to the material buyer the thus prepared quotation by attaching necessary drawings and technical data thereto (S108). When the quotations have been received from the makers, the material buyer performs technical evaluations and cost and delivery time evaluations by comparing the quotations received from the different makers (S109) and selects an order supplier based thereon (S110). Following this, the material purchaser places an order with the maker thus selected. Upon receipt of the order, the maker confirms its acceptance of the order (S111) and then prepares detailed technical data which include mill sheets (inspection records), outside dimensions, 3D CAD data (digitized shape information) and so forth on the material to be supplied (S112), and sends the detailed technical data to the material buyer. This transmission is partly made offline. Then, the material buyer receives the technical data, and the process of material quotation and ordering is completed (S113).

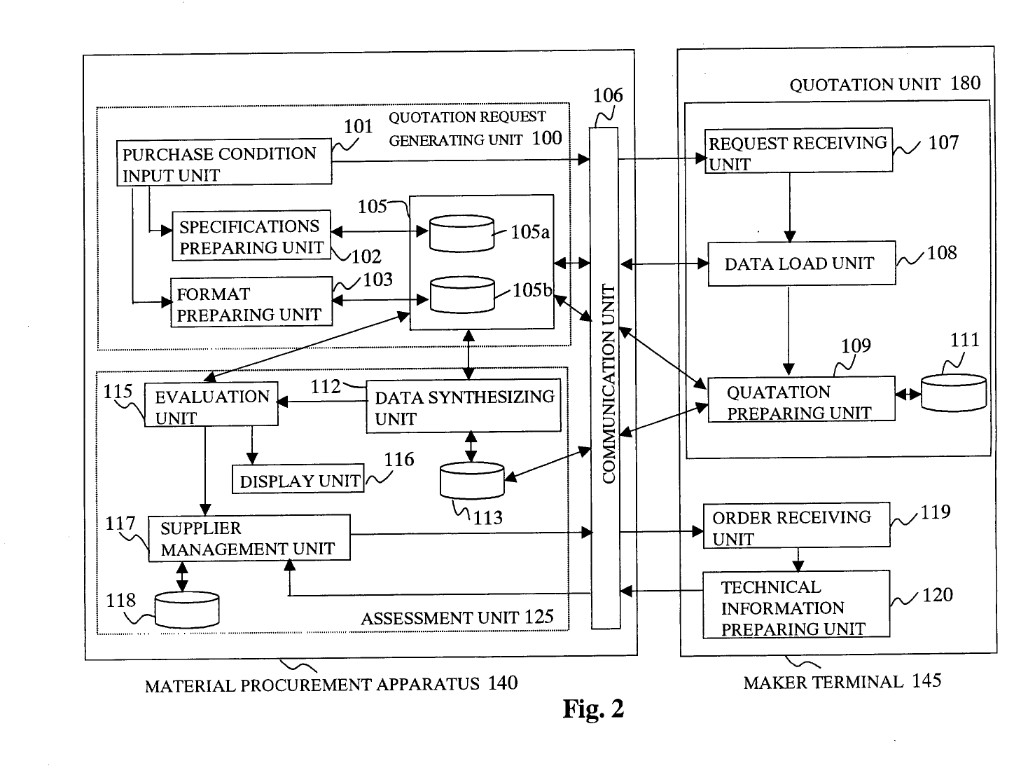

The above-described is one example of the general flow of material procurement operation assumed by the present invention. Next, referring to FIG. 2, a detailed description will be given of a flow of operation in the procurement of materials. FIG. 2 is a schematic block diagram showing an outline structure of a material procurement apparatus 140 according to the present embodiment. The material procurement apparatus 140 comprises a quotation request generating unit 100 and an assessment unit 125. The quotation request generating unit 100 requests makers to submit their quotations while the assessment unit 125 provides the material buyer with data with which he/she can compare and evaluate a plurality of quotations received. The material procurement apparatus 140 and each of maker terminals 145 are connected via a network. The communication unit in the maker terminal 145 is omitted in FIG. 2. In terms of hardware, the illustrated structure can be realized by a CPU, memory and other LSIs of an arbitrary computer. In terms of software, it is realized by memory-loaded programs or the like with reservation management function. Here, however, the structure is represented by functional blocks realized in cooperation with such components. Therefore, it should be understood by those skilled in the art that these functional blocks can be realized in a variety of forms by hardware only, software only or by the combination thereof.

A description will now be given of a flow of material procurement operation using a network system shown in FIG. 2. First, purchase conditions are inputted to a purchase condition input unit 101 by the material buyer. In this process, not only the required specifications for the material desired but also a format that makers (material suppliers) utilize in preparing their quotations will be inputted, and, besides, makers to whom quotation is requested are specified and so forth. The inputted required specifications and format are sent to a specifications preparing unit 102 and a format preparing unit 103, respectively, where data on the required specifications and format are processed into a form in which the makers are requested to submit their quotations. Information thus processed is stored in a specifications storage 105a and a format storage 105b, respectively.

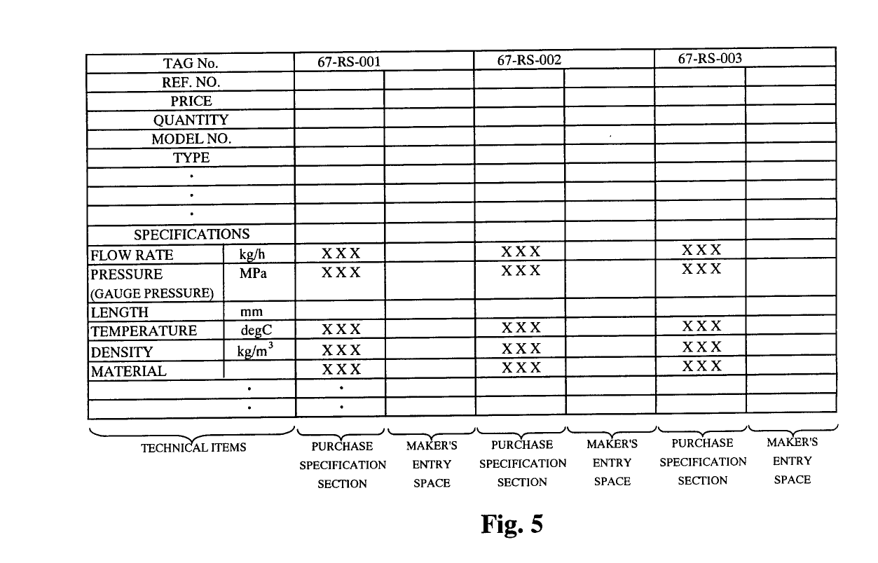

When the request for quotation is prepared, confirmation Email is transmitted from the purchase condition input unit 101 to each of the maker terminals 145 via a communication unit 106. After receiving this confirmation Email, a quotation unit 180 carries out a quotation processing in the following manner. The confirmation Email is received by a request receiving unit 107, and thereupon a data load unit 108 downloads required specifications and a format for quotation from a storage 105. Based on information thus obtained, a quotation preparing unit 109 prepares a quotation in a manner that necessary data are inputted to the format stored in the format storage 105b. An input sheet to be used may be one as shown in FIG. 5, for instance. The sheet shown in FIG. 5 is an example of a quotation for a specific piping material, where a plurality of piping quotations can be inputted for a single quotation. Generally, there are a plurality of products with specifications close to the required specifications and they have different costs and delivery time, so that a plurality of candidate products are to be included in a single quotation. The maker thus prepares a quotation by entering numerical values and other data for technical items listed in a table for each product. In FIG. 5, the format is structured such that quotations for three types of materials (67-RS-001, 67-RS-002 and 67-RS-003) are requested.

By requesting the makers to submit their quotations using a format like this, the material purchaser can handle contents of a plurality of quotations in a uniform and controlled manner and compare quickly and accurately a plurality of quotations received by listing all results thereof up in a table. To facilitate such comparison, the format shown in FIG. 5 has units given in the entry blanks for the technical items. The way in which the maker sides (suppliers) are required to enter their numerical values after unit conversion makes comparison of a plurality of quotations further easier.

Referring back to FIG. 2, the quotation prepared is stored in a quotation storage 111 and at the same time uploaded to a quotation data storage 113 of the material purchaser. The fact that a quotation has been prepared is communicated each time to the material purchaser by confirmation Email. The material purchaser checks the received quotations when a plurality of quotations have been collected. The checking of the quotations is done by a data synthesizing unit 112. The data synthesizing unit 112 prepares a table by reading out the format from the format storage 105b and synthesizing this read-out format with quotation results stored in the quotation data storage 113.

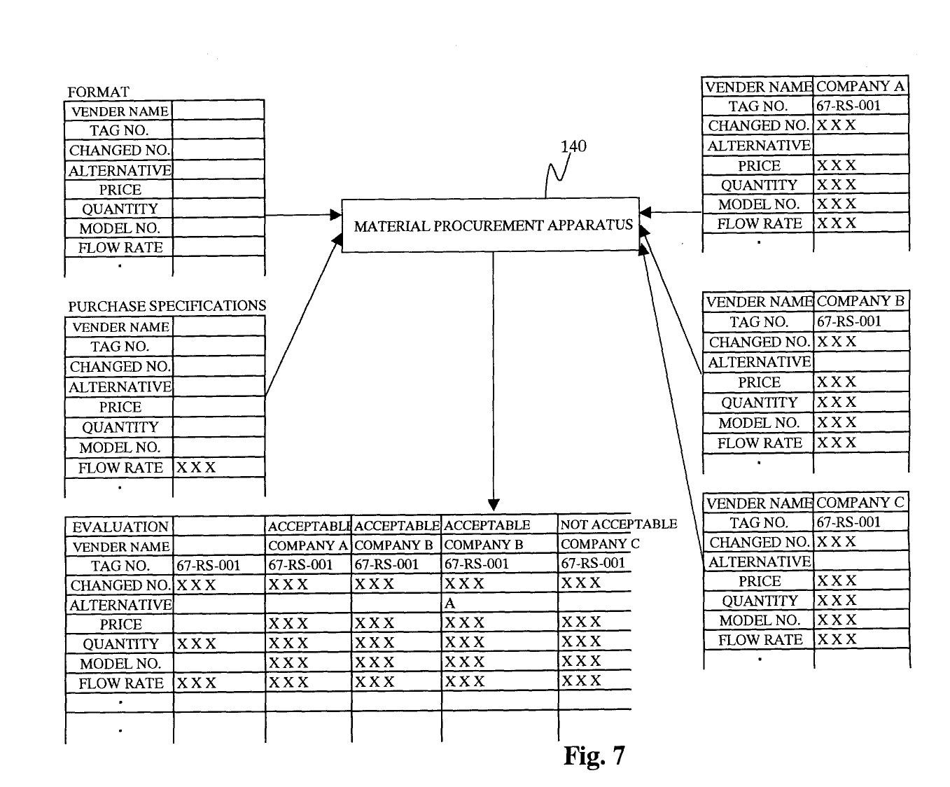

FIG. 7 explains a method of preparing this table. The material procurement apparatus 140 acquires a quotation file from each maker. Data contained in these files are arranged in a predetermined format so as to prepare a synthesized quotation file.

Here, the quotation data storage 113 stores temporarily the data received from the quotation preparing unit 109. However, an SQL (Structured Query Language) database or the like may be arranged between this quotation data storage 113 and the data synthesizing unit 112, so that the data synthesizing unit 112 may acquire the data from this database and carry out data synthesis thereon.

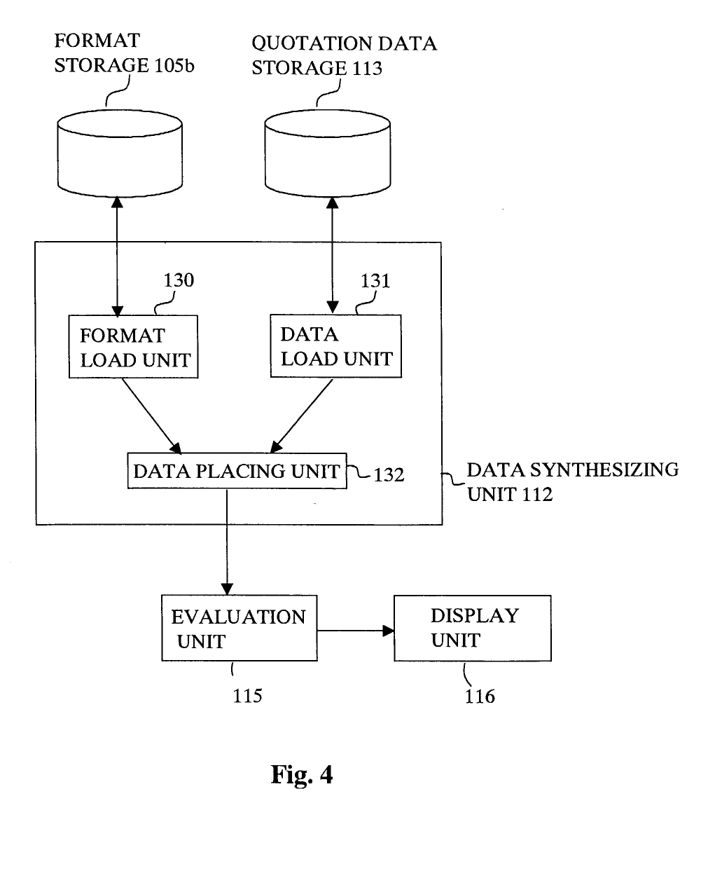

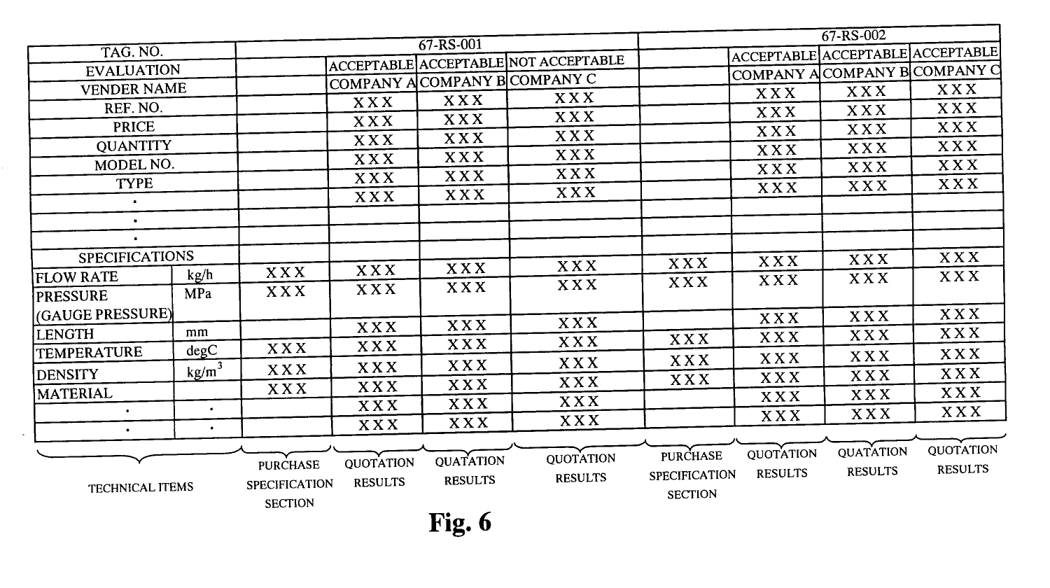

This process will be explained with reference to FIG. 4. The data synthesizing unit 112 comprises a format load unit 130, a data load unit 131 and a data placing unit 132. The format load unit 130 loads the format from the format storage 105b. The data load unit 131, on the other hand, loads the quotation data prepared by the maker from the quotation data storage 113. The data placing unit 132 synthesizes data by placing quotation data in predetermined positions of the format. The synthesized data are then sent to an evaluation unit 115, and a table created as a result of the synthesis is displayed by a display unit 116. FIG. 6 is a table showing an example of such a display. By using this table, the quotations from the makers can be easily compared at a glance. The comparison of quotations here is drawn comprehensively by comparing not only the costs but also the specifications, delivery time and the like of products. Thus, the listing of all the quoted items in a table as shown in FIG. 6 facilitates a quick and accurate decision in selecting a supplier with whom an order will be placed.

Referring back again to FIG. 2, the synthesized data prepared by the data synthesizing unit 112 are sent to the evaluation unit 115, where technical evaluation as well as cost and delivery time evaluation are carried out by comparing the quotations. At this time, the evaluation unit 115 confirms the quotations sent from the makers as to whether or not the quotations are in agreement with the required specifications, by referring to the required specifications stored in the specifications storage 105a.

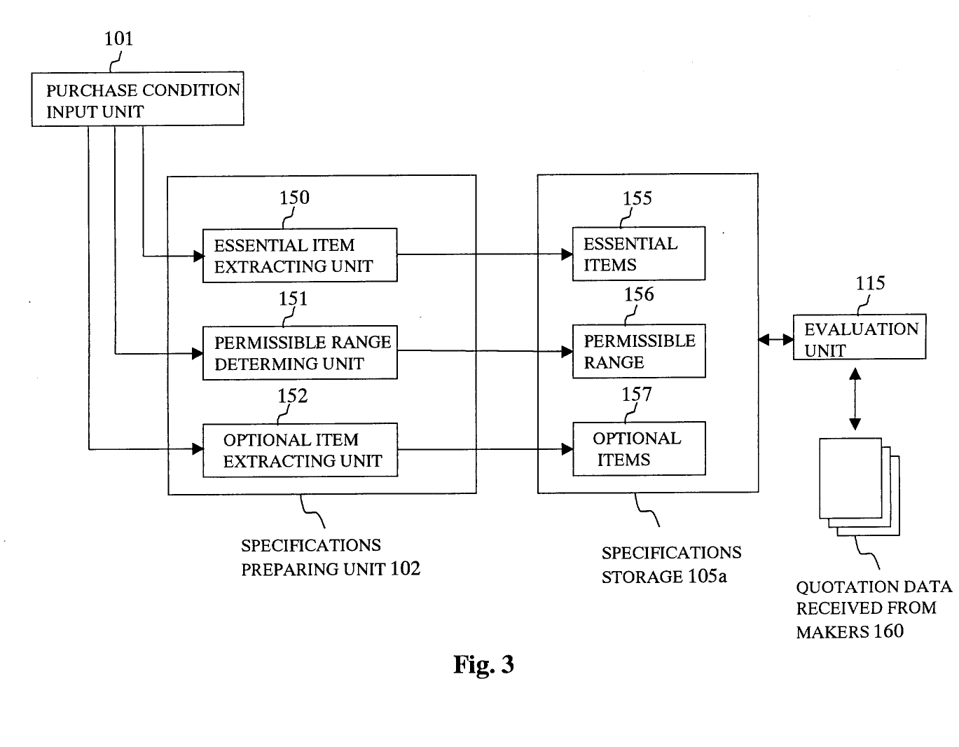

This process will be explained with reference to FIG. 3. The purchase condition input unit 101 receives the input of required specifications for a material from the material buyer and sends the data to the specifications preparing unit 102. The required specifications include essential items (fixed portions) that must always be satisfied and arbitrary or optional items (variable portions) that do not necessarily satisfy the required specifications. And the specifications of the essential items include preferable ranges and permissible ranges. The specifications preparing unit 102 extracts these kinds of information, respectively. Namely, on the basis of purchase conditions added with these kinds of information, an essential item extracting unit 150, a permissible range determining unit 151 and an optional item extracting unit 152 extract essential items 155, permissible ranges 156 and optional items 157, respectively, and store them in a specification database 105a. The evaluation unit 115 compares the above-mentioned items and ranges stored in the specification database 105a with quotation data 160 received from the makers, and judges a relation between the essential items 155, their corresponding permissible ranges 156 and the specifications presented by the makers. For cases where any of the specifications presented by the makers is out of the required specification range, a structure can be adopted such that the portion corresponding to the applicable item in the table is highlighted in the display, or the like. Such a structure makes the comparison of quotations much easier.

Referring back again to FIG. 2, the table and the results of evaluation are not only displayed by the display unit 116 but also sent to a supplier management unit 117. The display unit 116 urges the material buyer to decide on a supplier by displaying the table or the like, and in response thereto the material buyer selects a supplier and inputs his/her selection to the supplier management unit 117. In response thereto, the supplier management unit 117 transmits an order message to the selected supplier. The order is received by an order receiving unit 119 of the maker side and forwarded to a technical information preparing unit 120.

Upon receipt of the order, the maker who accepts the order prepares detailed technical data, including the mill sheets, outside dimensions, 3D CAD data and so forth, on material to be supplied. The outside dimension for major portions, instead of 3D CAD data, may be prepared and sent to the material buyer.

Of these data, those that can be digitized are inputted to the technical information preparing unit 120 and then transmitted to the supplier management unit 117 of the material procurement apparatus 140. The supplier management unit 117 stores these data in a supplier storage 118. Those of technical data that cannot be digitized are sent separately by mail or other means from the supplying maker to the material buyer.

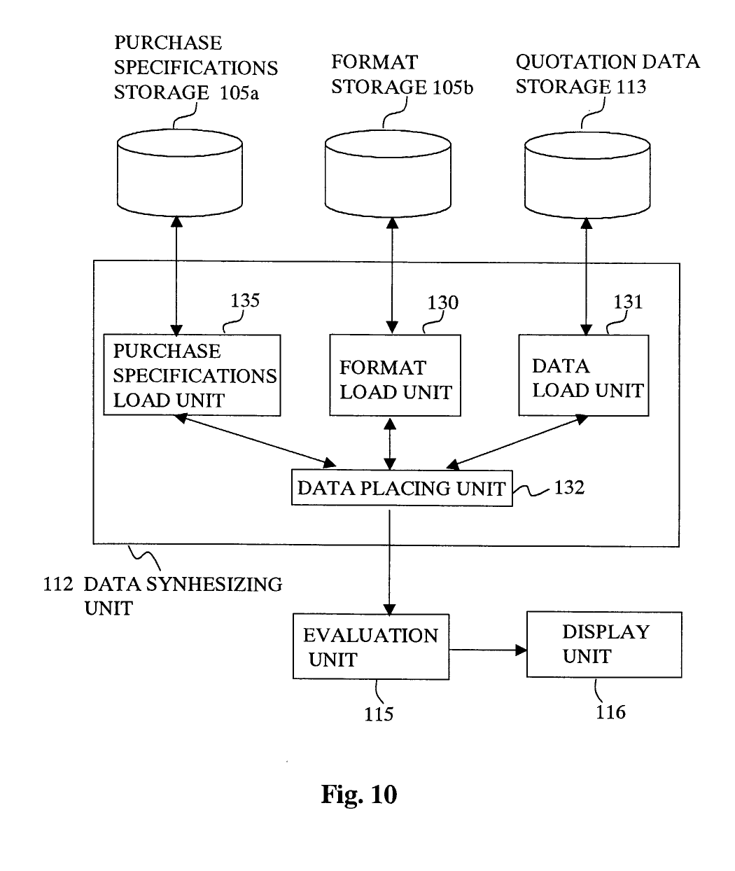

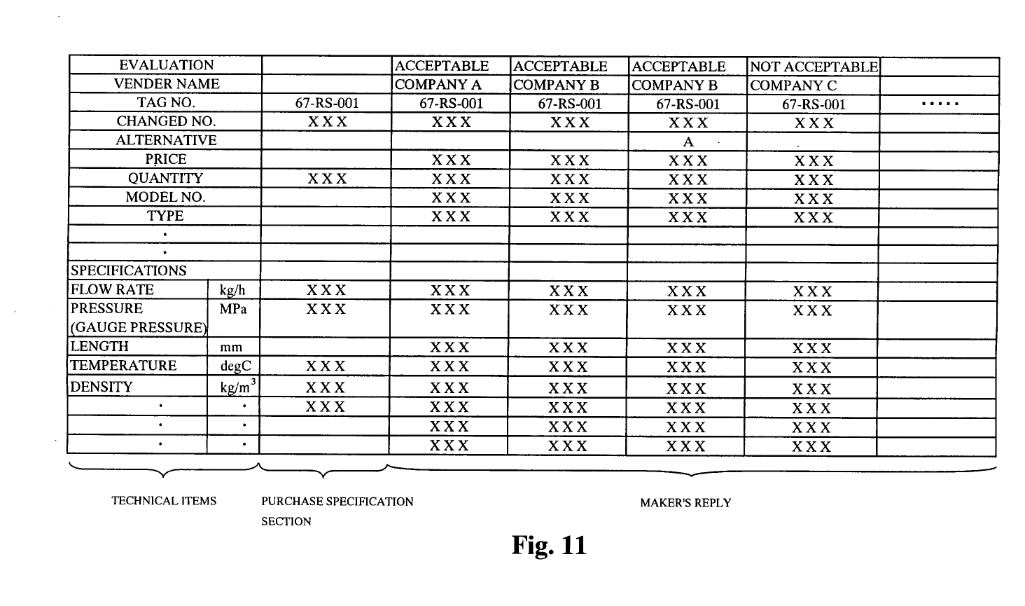

In the above-described embodiment, purchase specifications may be inserted in the table (see FIG. 11) in the event of synthesis of the quotation results shown in FIG. 6. In the synthesized quotation table shown in FIG. 11, quotations for a single material (67-RS-001) are obtained from a plurality of makers, and two quotation results including an alternative plan are submitted from company B. In the quotation table shown in FIG. 11, the above quotation results can be compared easily while the purchase specifications are being checked. FIG. 10 shows a structure of the data synthesizing unit 112 which prepares these synthesized quotation tables. The structure shown in FIG. 10 differs from that shown in FIG. 4 in that a purchase specifications storage 105a and a purchase specifications load unit 135 are added. The purchase specifications load unit 135 loads purchase specifications from the purchase specifications storage 105a, and sends out this purchase specifications to the data placing unit 132. The data placing unit 132 prepares a table of quotation results by placing this purchase specifications and quotation data in predetermined positions of the format. Thereby, the quotation results for the respective makers can be compared while comparing the specifications of the quoted product and its required specifications, so that comprehensive judgment can be made quickly and accurately.

Second Embodiment

In the first embodiment, the format prepared by the format preparing unit 103, the format which will be used thereafter at the time of preparing quotation, and the quotation data sent from maker terminals to the material procurement apparatus 140 are data all of which belong to CSV (Comma Separated Value) formats. In this respect, the structure thereof differs from a system which conducts the electronic commerce by utilizing data having a structure such as XML. In the present embodiment, the network load at the time of sending and receiving the format and quotation data can be reduced by utilizing data of the CSV format. Since the request for quotation of material usually involves numerous quotation requests, the merit attained by this load reduction is rather significant. In the system utilizing the XML, environment in which the XML required for conducting this transaction can be handled needs be fully provided at a maker side. In the case of CSV-format data, the transaction can be handled by preparing predetermined application software therefor, so that the burden on the maker side is small.

Moreover, the CSV data can be handled by general-use spreadsheet software or the like, thus facilitating the input of quotation. For example, in a case where numerical values are to be inputted from a browser screen at the time of inputting the quotation, the numerical values need to be inputted one by one for every input item, whereas, in a case when the spreadsheet software is used, an operation method in which the numerical values already inputted are copied and pasted or the like can be used in a combined manner, thus improving working efficiency. Moreover, inputting is possible without being connected to the Internet, and in this respect, too, operating efficiency thereof is superior.

The CSV data are utilized in the present embodiments. However, it is to be noted that text data where data such as numerical values are separated or delimited by a tab or blank space for each item can also be used. In other words, it suffices if adopted is the data format that can be easily handled by the software for general use with spreadsheets.

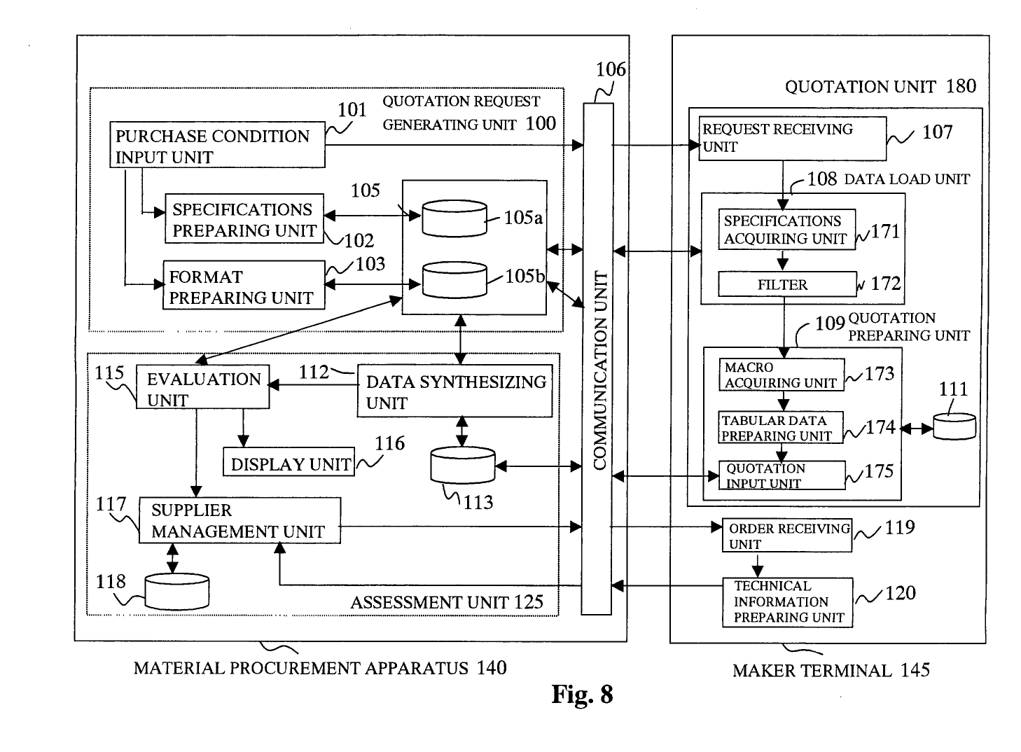

FIG. 8 shows a structure of a system including a material procurement apparatus according to a second embodiment. In recent years, data having XML formats are often used in the electronic commerce. Thus, there is a case where a material procurer (material buyer) exchanges data in the XML data with clients and also exchanges data in CSV data with the other clients. In order to be able to cope with this situation, the material buyer prepares the required specifications by using XML format data and sends the thus prepared specifications to makers, in the second embodiment. At makers' sides, quotation is prepared after the XML data are once converted to the CSV data.

The system shown in FIG. 8 has the structure that is almost the same as that of the system shown in FIG. 2. However, the structure differs in the quotation unit 180. Specifically speaking, the structure differs in the data load unit 108 and the quotation preparing unit 109 at the maker terminal. The data load unit 108 includes a specifications acquiring unit 171 and a filter 172. The quotation preparing unit 109 includes a macro acquiring unit 173, a tabular data preparing unit 174 and a quotation input unit 175.

In the present embodiment, the quotation input at the maker terminal 145 is data-processed not in the XML format but in the CSV format.

Hereinbelow, a data processing for this system will be described with emphasis on different points compared to FIG. 2.

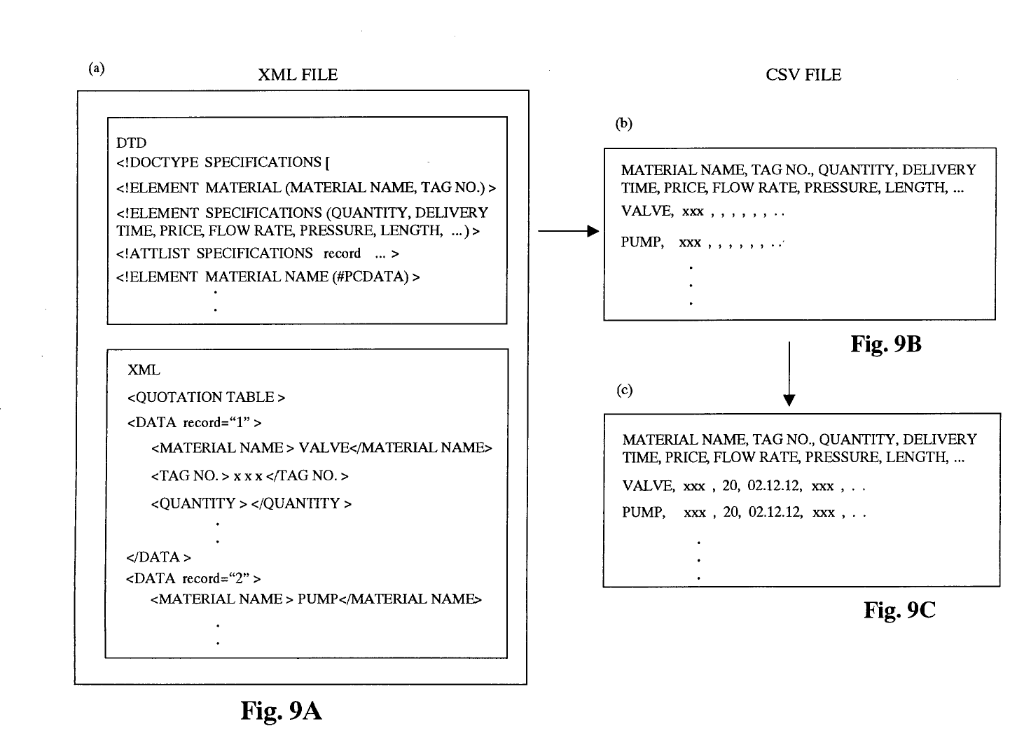

When the request receiving unit 107 receives a request for quotation, the specifications acquiring unit 171 downloads required specifications from the storage 105a. This required specifications are data that have a structure of the XML formats. Specifically speaking, the required specifications are such data as shown in FIG. 9A. Namely, this data includes a portion containing a definition relating to a tag called DTD (Document Type Definition) and a portion corresponding to XML files. The XML file portion is described in a manner that each of data items constituting the required specifications has an attribute. The filter 172 deletes tag data of this XML data, that is, data such as <material name></material name>, and converts them to CSV-format data. FIG. 9B shows a data structure after the conversion.

Thereafter, the above CSV-format data are delivered to the macro acquiring unit 173. The macro acquiring unit 173 downloads from the format storage 105 a format and an macro instruction which presents said format on application software utilized by makers.

After the downloading, the macro acquiring unit 173 delivers the above CSV-format data, the format and the macro instruction to the tabular data preparing unit 174. The tabular data preparing unit 174 prepares a table for use in quotation input, by synthesizing them and sends out this table to the quotation input unit 175. The quotation input unit 175 presents this table to a quotation maker so as to receive the input of quotation. When quotation is inputted as shown in FIG. 9C, its result is transmitted from the maker terminal 145 to the material procurement apparatus 140.

Operations for the system shown in FIG. 8 have been described. According to this system, the processing based on the XML data are performed in the material procurement apparatus 140 while the processing based on the CSV data is performed in the maker terminal 145. Thus, data exchange with various clients can be made in a relatively easy manner in the material procurer while at the maker sides the working efficiency for the input of quotation can be improved.

The present invention has been described based on embodiments which are only exemplary. It is understood by those skilled in the art that there exist other various modifications to the combination of each component and each processing described and that such modifications are encompassed by the scope of the present invention.

For example, though not shown in FIG. 2, the storage 105 may have not only the specifications storage 105a and the format storage 105b but also other storage means capable of storing desired payment method (payments at ordering, inspection and acceptance inspection, and so forth), desired delivery time and various other items.

Moreover, the quotation data stored in the quotation data storage 113 can be taken advantage of as reference data in selecting a maker who will be requested to submit quotation next time. For example, a structure can be employed where the purchase condition input unit 101 accesses the quotation data storage 113 so that the makers who have supplied materials in the past are presented to a maker who will be requested to submit quotation, and the results of quotation are presented to those who will be inputting data.

Moreover, though the preferred embodiments according to the present invention have been described relative to the flow of material procurement for a single construction, a greater cost advantage can be gained by carrying out material procurement for a plurality of works simultaneously in cooperation therewith in which common materials are ordered together.

As have been described so far, the required specifications and the format are handled separately and the material suppliers are asked to prepare their quotations in accordance with a uniform format, according to the present embodiments. Thus, the burden on the material suppliers and the material purchaser in the transmission and reception of data is reduced and the comparison of quotations can be carried out quickly and accurately.

Although the present invention has been described by way of exemplary embodiments, it should be understood that many changes and substitutions may further be made by those skilled in the art without departing from the scope of the present invention which is defined by the appended claims.

What is claimed is:

1. A material procurement apparatus, connected to material suppliers via a network, comprising:
a quotation request generating unit which prepares a request for quotation and sends the quotation request to the material suppliers; and
an assessment unit which receives quotation data received from the material suppliers,
said quotation request generating unit including:
a specifications preparing means for preparing required specifications of material;
specifications storage means, accessible from the material suppliers, for storing the required specifications;
format preparing means for preparing a format utilized when the material suppliers prepare quotation;
format storage means, accessible from the material suppliers, for storing the format; and
quotation requesting means which sends to the material suppliers a quotation request including an inquiry about a specification and a price of a product that can be supplied, and which requires the material suppliers to access said specifications storage means and said format storage means to download the required specifications and the format and to prepare replies to the quotation request along the format by referring to the required specifications, and
said assessment unit including:
quotation result storage means which receives quotation results prepared along the format and stores the quotation results; and
a data synthesizing unit which synthesizes a plurality of quotation results received from a single or plurality of material supplier(s) and the format read out from said format storage means, and prepares a table for the plurality of quotation results.

2. A material procurement apparatus according to claim 1, wherein said quotation requesting means requests to download a macro instruction presenting the format, on application software utilized, together with the format, when the material supplier prepares quotation.

3. A material procurement apparatus according to claim 1, wherein the format does not contain tag data therein.

4. A material procurement apparatus according to claim 2, wherein, in the event that the format contains tag data, the macro instruction includes an instruction to delete the tag data.

5. A material procurement apparatus according to claim 1, wherein the required specifications include essential items that must satisfy the required specifications and arbitrary items that do not necessarily satisfy the required specifications.

6. A material procurement apparatus according to claim 1, wherein said assessment unit further includes display means for displaying the table, and said display means displays an item that does not meet any of requested specifications among the quotation results, in an emphasized manner.

7. A material procurement apparatus according to claim 1, wherein said assessment unit further includes supplier management means which receives data on a specified supplier from a material buyer and sends a purchase request to the specified supplier.

8. A material procurement system, including a material procurement apparatus and material suppliers connected to said material procurement apparatus via a network,
said material procurement apparatus comprising:
a quotation request generating unit which prepares a request for quotation and sends the quotation request to the material suppliers; and
an assessment unit which receives quotation data received from the material suppliers,
said quotation request generating unit including:
a specifications preparing means for preparing required specifications of material;
specifications storage means, accessible from the material suppliers, for storing the required specifications;
format preparing means for preparing a format utilized when the material suppliers prepare quotation;
format storage means, accessible from the material suppliers, for storing the format; and
quotation requesting means which sends to the material suppliers a quotation request including an inquiry about a specification and a price of a product that can be supplied, and which requires the material suppliers to access said specifications storage means and said format storage means to download the required specifications and the format and to prepare replies to the quotation request along the format by referring to the required specifications, and
said assessment unit including:
quotation result storage means which receives quotation results prepared along the format and stores the quotation results; and
a data synthesizing unit which synthesizes a plurality of quotation results received from a single or plurality of material supplier(s) and the format read out from said format storage means, and prepares a table for the plurality of quotation results,
wherein each of the material suppliers is equipped with:
a request receiving unit which receives a request for quotation from said material procurement apparatus; and
a quotation unit which downloads the required specifications and the format by accessing said specifications storage means and said format storage means when the quotation request is received, and which prepares a reply to the quotation request in compliance with the format by referring to the required specifications.

9. A material procurement system according to claim 8, wherein said quotation unit downloads a macro instruction presenting the format, on application software utilized, together with the format, when the material supplier prepares quotation, and prepares a reply to the quotation request in compliance with the format presented by the macro instruction.

10. A material procurement system according to claim 8, wherein the format does not contain tag data therein.

11. A material procurement system according to claim 8, wherein, in the event that the format contains tag data, said quotation unit deletes the tag data.

12. A material procurement system according to claim 8, wherein the required specifications include essential items that must satisfy the required specifications and arbitrary items that do not necessarily satisfy the required specifications.

13. A material procurement system according to claim 8, wherein said assessment unit further includes display means for displaying the table, and said display means displays an item that does not meet any of requested specifications among the quotation results, in an emphasized manner.

14. A material procurement system according to claim 8, further including supplier management means which receives data on a specified supplier from a material buyer and sends a purchase request to the specified supplier.

15. A material procurement method utilizing a material procurement apparatus, connected to material suppliers via a network, including storage means accessible from the material suppliers, the method comprising:
preparing required specifications and a format utilized when the material suppliers prepare quotation;
storing the required specifications and the format in the storage means;
sending to the material suppliers a quotation request including an inquiry about a specification and a price of a product that can be supplied, and requiring the material suppliers to access the storage means to download the required specifications and the format and to prepare replies to the quotation request along the format by referring to the required specifications;
receiving quotation results prepared along the format, from the material suppliers; and
synthesizing a plurality of quotation results received from a single or plurality of material supplier(s) and the format read out from the storage means, and preparing a table for the plurality of quotation results.

16. A material procurement method according to claim 15, wherein the material procurement apparatus requests to download a macro instruction presenting the format, on application software utilized, together with the format, when the material supplier prepares quotation.

17. A material procurement method according to claim 15, wherein the format does not contain tag data therein.

18. A material procurement method according to claim 16, wherein, in the event that the format contains tag data, the macro instruction includes an instruction to delete the tag data.

19. A material procurement method according to claim 15, wherein the required specifications include essential items that must satisfy the required specifications and arbitrary items that do not necessarily satisfy the required specifications.

20. A material procurement method according to claim 15, further including displaying the table in a manner that an item that does not meet any of required specifications among the quotation results is emphasized.

21. A material procurement method according to claim 15, after preparing the table for a plurality of quotation results, further including displaying the table, receiving data on a specified supplier from a material buyer and sending a purchase request to the specified supplier.
